(19) United States
(12) Patent Application Publication
(10) Pub. No.: US 2008/0315561 A1
(43) Pub. Date: Dec. 25, 2008

(54) Trailer tongue pivot hinge with integrated receiver

(76) Inventors: Eric Anderson, Plover, WI (US); Kawa-She-Quoen Okerlund, Wittenberg, WI (US); Todd Walstrom, Weston, WI (US); Frank Drake, Wausau, WI (US)

Correspondence Address: MCDONALD HOPKINS LLC, 600 Superior Avenue, East, Suite 2100, CLEVELAND, OH, 44114-2653, US

(21) Appl. No.: 12/154,390

(22) Filed: May 22, 2008

Related U.S. Application Data
(63) Continuation-in-part of application No. 12/148,860, filed on Apr. 23, 2008.
(60) Provisional application No. 60/925,784, filed on Apr. 23, 2007.
(60) Provisional application No. 60/931,219, filed on May 22, 2007.

(51) Int. Cl. B60D 1/54

(52) U.S. Cl. 280/491.1

(57) ABSTRACT

Apparatus, methods, and other embodiments associated with a trailer tongue pivot hinge are described herein. In an embodiment, a pivot assembly for a towing trailer includes a first adapter and a second adapter. The first adapter is arranged to be attachable to a first trailer frame member and includes a body; an engagement face forming a front surface of the body; a pivot hinge member extending from the engagement face; and a coupling hinge member extending from the engagement face and opposed to the first pivot hinge member; and a receiver. The receiver is adapted for securing a trailer accessory to the first adapter. The second adapter is arranged to be attachable to a second trailer frame member and pivotably attachable to the first adapter.

### CROSS-REFERENCE TO RELATED APPLICATIONS

This application is a continuation-in-part of U.S. patent Ser. No. 12/148,860 entitled “TRAILER TONGUE PIVOT HINGE,” filed on Apr. 23, 2008, which claims priority from U.S. Provisional Patent Application No. 60/925,784 entitled “HEAVY DUTY PIVOT HINGE,” filed on Apr. 23, 2007, and this application claims priority from U.S. Provisional Patent Application No. 60/931,219 entitled “PIVOT CASING WITH AN INTEGRATED WINCH MOUNT RECEIVER,” filed on May 22, 2008, all of which are hereby incorporated by reference in its entirety.

### FIELD OF INVENTION

The present invention relates in general to trailers and, more particularly, to apparatus and methods for selectively adjusting the overall length of a trailer and securing accessories to the trailer.

### BACKGROUND

Large items or objects, such as vehicles, boats, cargo, and the like are often placed onto trailers for transporting from one location to another. Such trailers are commonly coupled to towing vehicles, such as trucks, sport utility vehicles, and the like to transport or tow the items between locations. Once a towed item reaches a destination, the item often remains stored on the trailer until the item is used or again transported. In one common example, recreational boats are generally stored on towing trailers when not in use. In cooler climates, such boats are often removed from lakes and other such bodies of water and stored during the winter months. As most recreational boats are owned by consumers, such boats are typically stored in residential garages when not in use.

It is common for certain types of recreational boats to be at least eighteen feet in length. Once a boat of this length is placed on an appropriate towing trailer, the storage space required to store the boat on the trailer is often larger than can be accommodated by a residential garage. Such a boat loaded onto the trailer may be twenty-four feet long or more, as measured from the most rearward point of the stern of the boat to the most forward portion of the trailer, which is typically the trailer coupler. The average length of a residential garage is less than twenty-four feet. The respective sizes of towing trailers and residential garages makes many garages ineffective as storage locations for trailered boats. With a portion of the trailer extending through the threshold of the garage, the garage door cannot be closed, resulting in exposing the boat to the elements and failing to adequately secure the boat, trailer, and other items stored in the garage.

There is a need for apparatus and methods for reducing the overall length of trailer to accommodate the storage of trailers in certain storage facilities, such as for example residential garages.

### SUMMARY OF INVENTION

Apparatus, methods, and other embodiments associated with a trailer tongue pivot hinge are described herein. In an embodiment, a pivot assembly for a towing trailer includes a first adapter and a second adapter. The first adapter is arranged to be attachable to a first trailer frame member and includes a body; an engagement face forming a front surface of the body; a pivot hinge member extending from the engagement face; and a coupling hinge member extending from the engagement face and opposed to the first pivot hinge member; and a receiver. The receiver is adapted for securing a trailer accessory to the first adapter. The second adapter is arranged to be attachable to a second trailer frame member and pivotably attachable to the first adapter.

### DESCRIPTION OF DRAWINGS

Operation of the invention may be better understood by reference to the following detailed description taken in connection with the following illustrations, wherein:

FIG. 1 is a side elevational view of a prior art trailer;

FIG. 2 is a partial perspective view of a trailer arm adapter pivotally connected to a coupler arm adapter;

FIG. 3 is a perspective view of a pivoting assembly incorporated into a trailer tongue and positioned in a towing position;

FIG. 4 is a perspective view of a pivoting assembly incorporated into a trailer tongue and positioned in a storage position;

FIG. 5 is a schematic cross-sectional view of an trailer arm adapter fastened to a trailer tongue;

FIG. 6 is a perspective view of a pivoting assembly incorporated into a trailer tongue and positioned in a towing position;

FIG. 7 is a perspective view of a pivoting assembly incorporated into a trailer tongue and positioned in a towing position;

FIG. 8 is a top view of a fastener aperture pattern for a pivot assembly;

FIG. 9 is a perspective view of a pivoting assembly with a receiver;

FIG. 10 is a perspective view of a pivoting assembly with a receiver;

FIG. 11 is a perspective view of an adapter with a plurality of receivers;

FIG. 12 is a perspective view of an adapter with a plurality of receivers receiving trailer accessories and secured to a trailer tongue; and

FIG. 13 is a perspective view of a pivoting assembly with a receiver receiving a trailer accessory and secured to an A-frame trailer.

### DETAILED DESCRIPTION OF INVENTION

While the present invention is described with reference to the embodiments described herein, it should be clear that the present invention should not be limited to such embodiments. Therefore, the description of the embodiments herein is illustrative of the present invention and should not limit the scope of the invention as claimed.

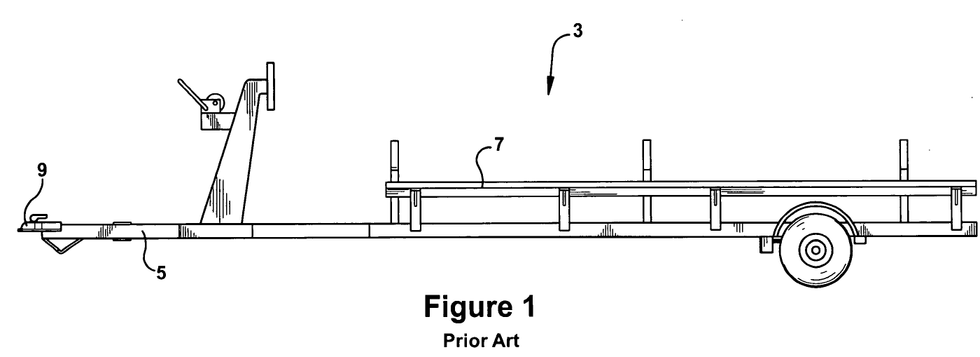

As illustrated in prior art FIG. 1, trailers 3 typically include a tongue or arm 5 extending from a body 7 of the trailer 3. The body 7 is arranged to secure cargo for transport from one location to another. Trailers typically include a coupler mechanism 9 positioned at or near the end of the tongue 5. The coupler 9 is arranged to connect or otherwise attach to a vehicle so that the trailer 3 may be towed. As shown in FIG. 1, the tongue 5 rigidly extends from the body 7, and the overall position and orientation of the tongue 5, with respect to the body 7, is fixed. As arranged in the prior art, the tongue 5 may extend from the body 7 of the trailer 3 such that the overall length of the trailer 3 makes it impossible for a door of a storage facility to be closed when the trailer 3 is parked within the storage facility.

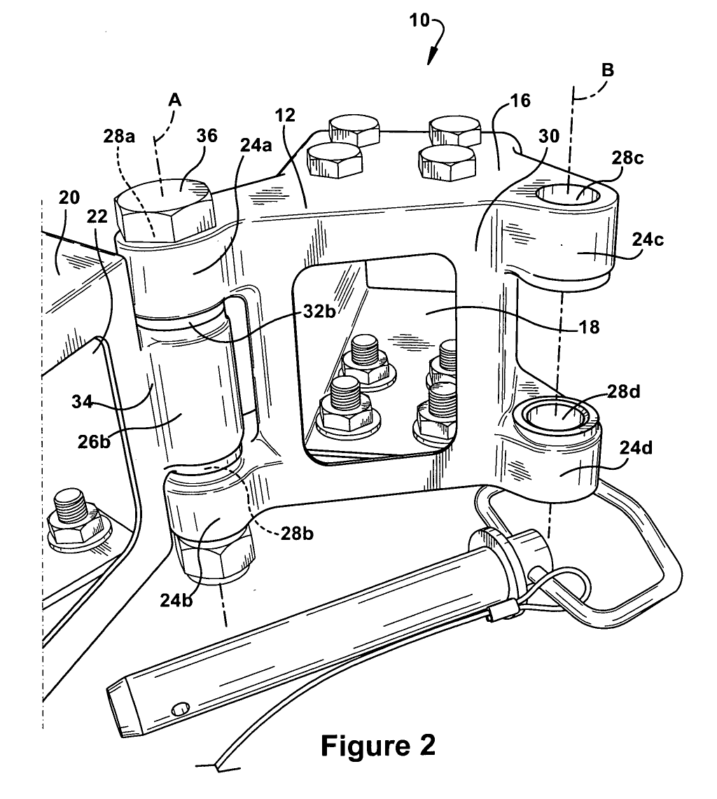

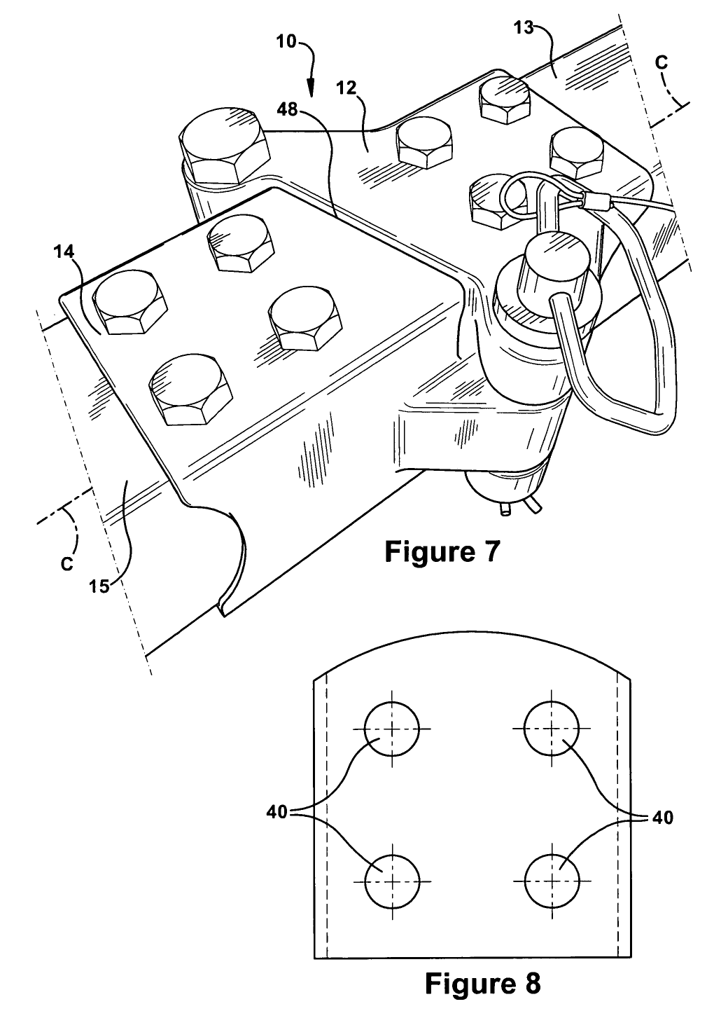

FIGS. 2 through 8 illustrate novel embodiments directed to apparatus and methods of selectively adjusting the overall length of a trailer. The figures show a pivoting assembly 10 that includes a trailer arm adapter 12 and a coupler arm adapter 14. As will be described and shown herein, the pivoting assembly 10 may be attached to, secured to, integrally formed with, or otherwise incorporated into a trailer to facilitate selectively adjusting the overall length of the trailer. Generally, the pivoting assembly 10 is incorporated into a trailer by dividing a tongue of the trailer into a trailer arm 13, leading to the body of the trailer, and a coupler arm 15, with a coupler attached at or near the end of the arm 15. The trailer arm adapter 12 is attached to, secured to, integrally formed with, or otherwise incorporated into the trailer arm 13. The coupler arm adapter 14 is attached to, secured to, integrally formed with, or otherwise incorporated into coupler arm 15. Once the trailer adapter 12 and coupler adapter 14 are incorporated into the trailer, the adapters 12, 14 may be pivotally coupled together to facilitate the adjustment of the overall length of a trailer.

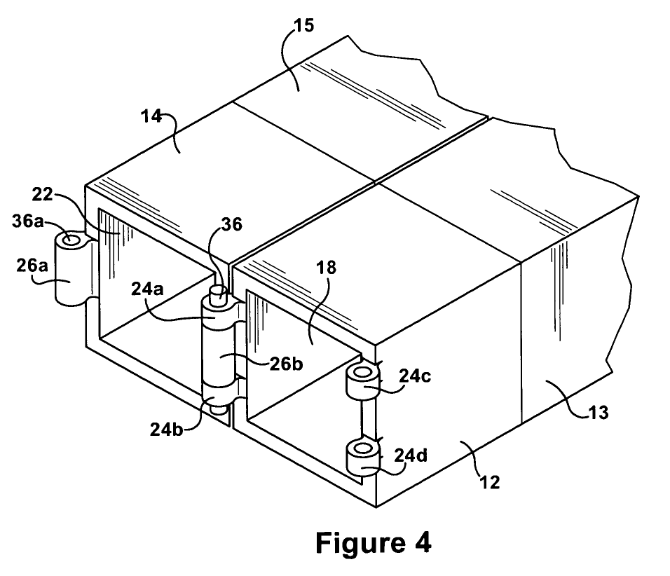

The trailer arm adapter 12 and the coupler arm adapter 14 may be hinged such that the coupler arm adapter 14 moves pivotally with respect to trailer arm adapter 12. Such pivotal movement allows the coupler arm 15 to fold back towards the trailer arm 13, thus reducing the overall length of the trailer. In an embodiment, as best illustrated by FIG. 4, the coupler arm 15 folds back to a position generally parallel to the trailer arm 13. The reduction in overall length of the trailer enables the trailer to be parked in smaller storage facility than would otherwise be practical.

Generally the tongue may be divided into a trailer arm 13 and a coupler arm 15 through any number of methods. In an embodiment, a prior art trailer may be retrofit to include a pivoting assembly 10 by cutting or severing the tongue at any point along the tongue to form a trailer arm 13 from the tongue portion remaining with the trailer and a coupler portion 15 from the portion of the tongue severed from the trailer. The pivoting assembly 10 may then be incorporated at the location of the cut. In another embodiment, the tongue may be manufactured to be shorter than current designs and a second arm may be manufactured containing a coupler. In such an arrangement, a pivoting assembly 10 may be inserted between the shortened tongue and the coupler arm to form a pivotable tongue extending from the trailer. In yet another embodiment the tongue may be manufactured with the pivoting assembly 10 integrally formed with the tongue. The embodiments described are exemplary only and other methods of incorporating a pivoting assembly 10 into a trailer will be readily understood by those skilled in the art upon reading and understanding this detailed description.

As shown in FIG. 2, the trailer arm adapter 12 may have a generally tubular construction, with a square exterior surface 16 and a generally square passage or chamber 18 passing through the adapter 12. The coupler arm adapter 14 may include a similar construction, with a generally square exterior surface 20 and a generally square passage or chamber 22 passing through the adapter 14. In one embodiment, the adapters 12, 14 may be manufactured or fabricated from heavy duty steel through any known process, such as forging, milling, stamping, molding, sintering, and the like.

Once incorporated into a trailer, the adapters 12, 14 may be pivotally attached to facilitate pivotal movement of one adapter with respect to the other adapter. Hinge members 24, 26 extending from the adapters 12, 14 may facilitate the pivotal attachment. As best seen in FIG. 2, the trailer arm adapter 12 includes four hinge members 24a, 24b, 24c, 24d. Each hinge member 24a, 24b, 24c, 24d extends from the body of the adapter 12 and includes an aperture or bore 28a, 28b, 28c, 28d passing therethrough. As shown, the hinge members 24a, 24b, 24c, 24d generally extend from the four corners of a surface 30 of the adapter 12. The bores 28a, 28b of a first pair of hinge members 24a, 24b align along a generally vertical axis A, and the bores 28c, 28d of a second pair of hinge members 24c, 24d align along a second generally vertical axis B. In another embodiment, the trailer arm adapter 12 may include only two hinge members 24 extending from opposing sides of the adapter 12.

The pivotal attachment is further facilitated by hinge members 26a, 26b, which extends from the body of the coupler arm adapter 14. As best seen in FIG. 4, the coupler arm adapter 14 includes two hinge members 26a, 26b. Each hinge member 26a, 26b generally extends from a midpoint the body of the adapter 14 and includes an aperture or bore 32a, 32b passing therethrough. As shown, the hinge members 26a, 26b are opposed to one another and extend from a surface 34 of the coupler arm adapter 14 that is arranged to mate or engage with a surface 30 of the trailer arm adapter 12.

As best seen in FIG. 2, a hinge member 26b of the coupler arm adapter 14 may be positioned such that its bore 32b aligns with the bores 28a, 28b of the first pair of hinge members 24a, 24b extending from the trailer arm adapter 12. In such an arrangement, the bores 28a, 28b, 32b are aligned along the axis A and a pivot pin 36 may be inserted or passed through the bores 28a, 28b, 32b to pivotably connect the trailer arm adapter 12 and the coupler arm adapter 14. Such an arrangement allows the coupler arm adapter 14 to rotate relative to the trailer arm adapter 12.

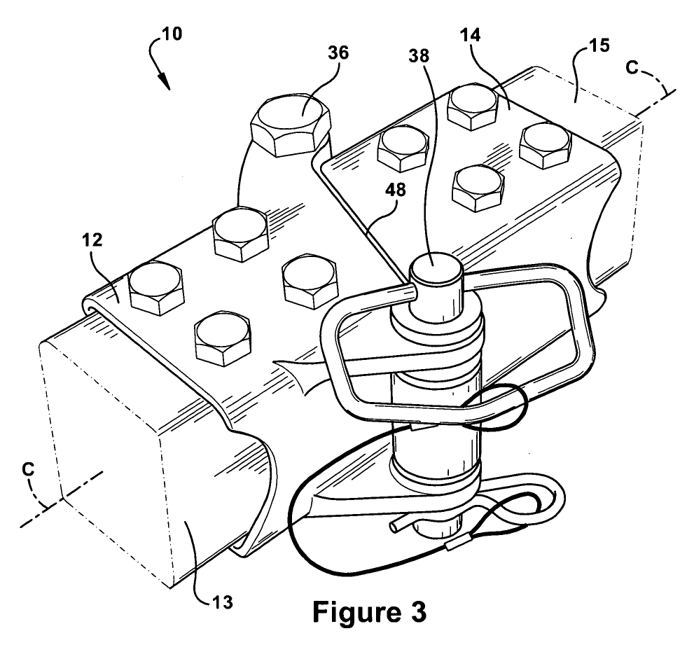

It will be readily understood by those skilled in the art that once the adapters 12, 14 are incorporated into a tongue of a trailer and pivotally connected, the coupler arm 15 is capable of rotating between a towing position, where the trailer arm 13 and coupler arm 15 are aligned along a common axis C (as seen in FIG. 3), and a storage position, where the coupler arm 15 is rotated approximately 180 degrees from the towing position and positioned along side the trailer arm 13 (as seen in FIG. 4).

Referring to FIG. 3, when the tongue is in the towing position, a hinge member 26a of the coupler arm adapter 14 is positioned such that its bore 32a aligns with the bores 28c, 28d of the second pair of hinge members 24c, 24d extending from the trailer arm adapter 12. In such an arrangement, the bores 28c, 28d, 32a are aligned along the axis B and a securing pin 38 may be passed through the bores 28c, 28d, 32a to secure the tongue in the towing position and preventing the coupler arm adapter 14 from rotate relative to the trailer arm adapter 12. In such an arrangement, the trailer arm 13 and the coupler arm 15 are secured such that the arms 13, 15 are aligned along a common axis C, and the arms 13, 15 are secured to function as a rigid tongue, by which the trailer may be towed.

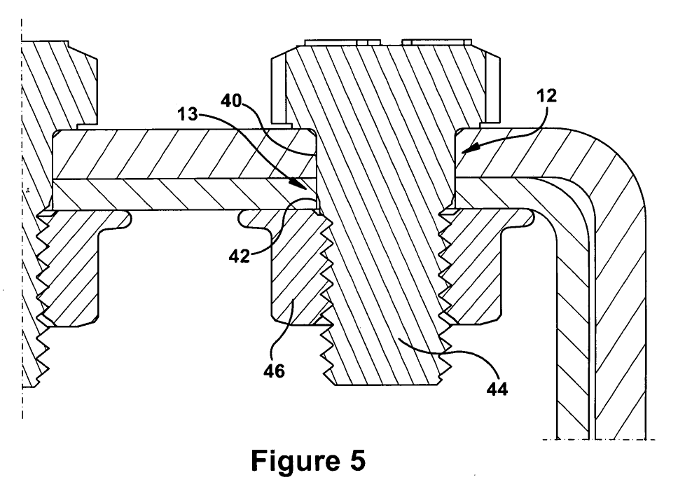

As described above, the adapters 12, 14 may be incorporated into the tongue in a number of ways. In one embodiment, each adapter 12, 14 includes a plurality of apertures 40 designed to accept bolts, pins, screws, rivets, or other such fasteners. The adaptors 12, 14 may be arranged to fit over the arms 13, 15 such that the adapters 12, 14 fit snuggly on all four sides of the arms 13, 15. As will be readily understood by those skilled in the art, the trailer arm 13 and coupler arm 15 may be manufactured, fabricated, or retrofitted with a matching plurality of apertures 42 to accept any bolts, pins, screws, rivets, or other such fasteners passed through the apertures 40 in the adapters. Once such fasteners are fastened in the matching apertures 42, the adapter 12, 14 may be secured to the respective arm 13, 15. In an embodiment, the adaptors 12, 14 may be reversibly coupled to the arms 13, 15 by a bolt 44 and nut 46 fastener system, as seen in FIG. 5. In another embodiment, the adapters 12, 14 may be nonreversibly secured to the arms 13, 15 by a punched rivet fastening system.

An embodiment of an aperture 40 pattern is illustrated in FIG. 8. As seen in FIGS. 3, 6, and 7, the apertures 40 and fasteners are preferably positioned in the top and bottom of the adapters 12, 14 and arms 13, 15. In such an arrangement the fasteners do not interfere with the arms 13, 15 when the tongue is in the stored position, as seen in FIG. 4.

In another embodiment, the adaptors 12, 14 are arranged to fit over the arms 13, such that the adapters 12, 14 fit snuggly on all four sides of the arms 13, 15. Once situated as such, the adaptors 12, 14 may be secured to the arms 13, 15 by a welding process. The adaptors 12, 14 may optionally include flanges (not shown) to facilitate the welding process.

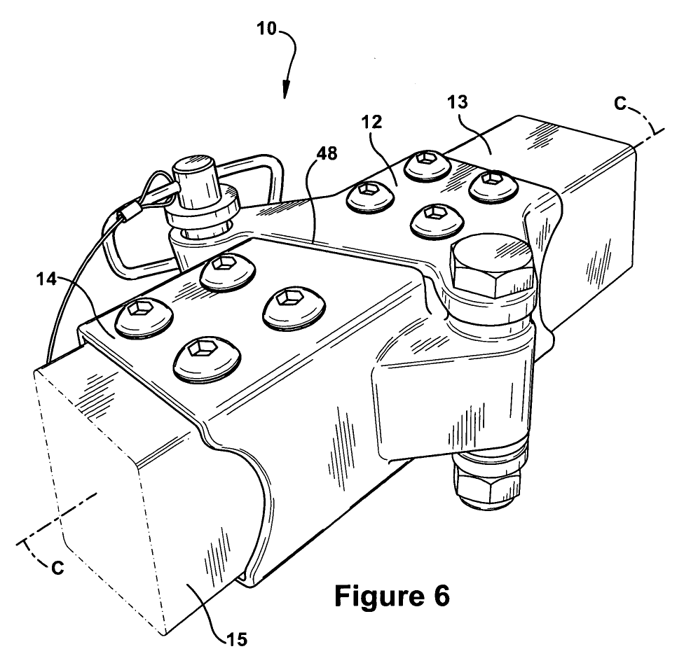

In an embodiment, the adapters 12, 14 are arranged such that they mate or engage along engagement faces or surfaces 30, 34 to form an interface 48 that is positioned at an angle with respect to a longitudinal axis passing through the arms 13, 15 or adapters 12, 14. As illustrated in FIG. 6, the adaptors 12, 14 mate along such an interface 48 when the arms 13, 15 are positioned in the towing position and aligned along the Axis C. In such an arrangement, the interface 48 is angled with respect to the axis C. Such an arrangement effectively distributes the load of towing the trailer and avoids concentrations of stress or force while the trailer is being towed.

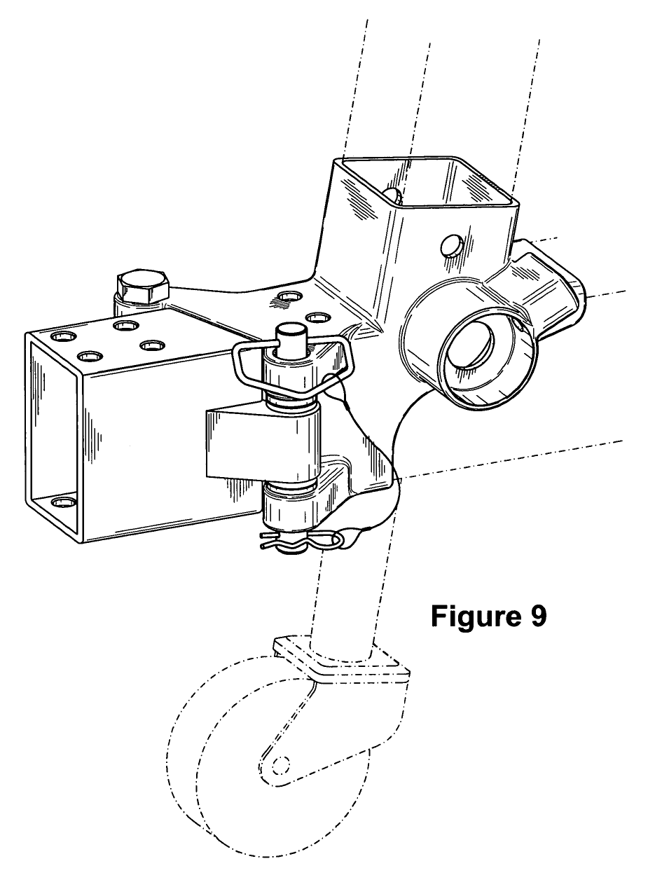

As illustrated in FIGS. 9-13, embodiments of a pivoting assembly may include features for securing trailer accessories to the trailer through attachment to the pivoting assembly. A pivoting assembly may be arranged to secure or otherwise fix a large variety of accessories to a trailer such as, for example, winches, winch stands; jacks, jack legs, jack stands, keel rollers, and the like.

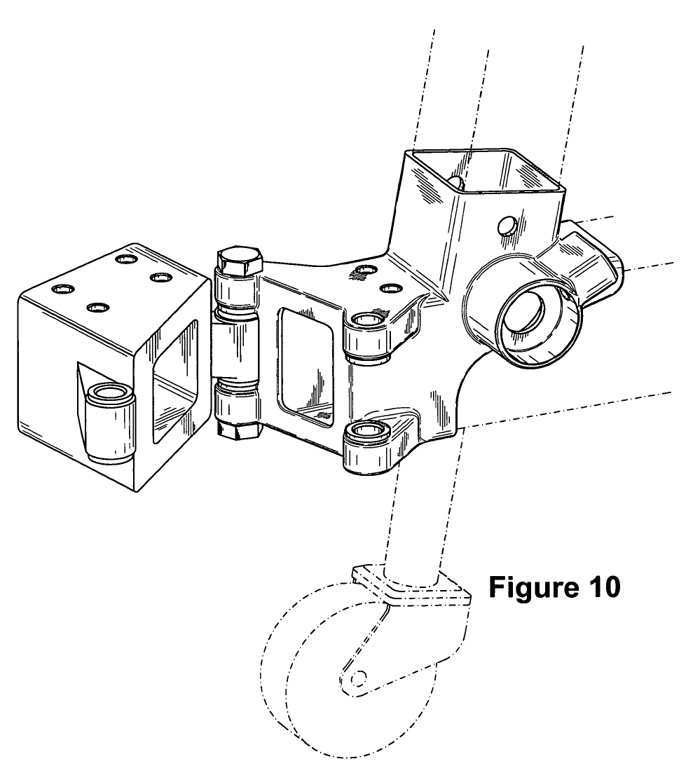

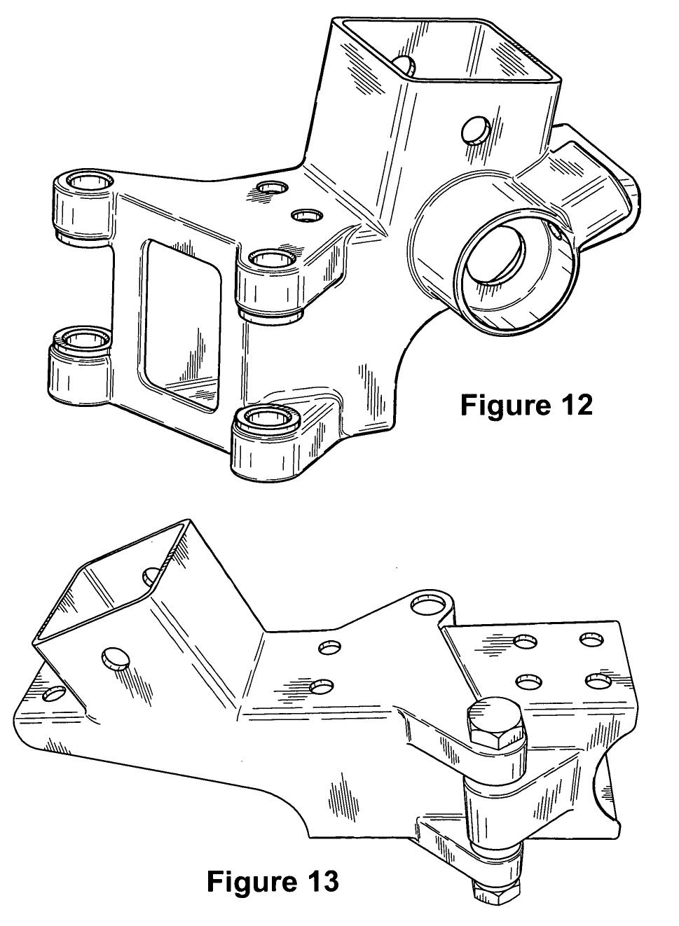

As illustrated in FIGS. 9 and 10, in an embodiment of an exemplary pivoting assembly 100 a receiver 150 or mounting tube may be incorporate into a trailer arm adapter 112. Such a receiver 150 may allow for a variety of trailer accessories to be secured to a trailer through the trailer adapter arm 112. In the embodiment shown in FIGS. 9 and 10 the receiver 150 is integrally formed with the trailer arm adapter 112. The adapter 112 and receiver 150 may be formed from a rigid material such as steel or a composite plastic and formed through casting, molding, or the like. The receiver 150 as illustrated is a hollow, square tube extending at an angle from a top surface 116 of the adapter 112 and arranged to accept an accessory such as a wench stand 300 (shown in FIG. 12).

The top surface 116 of the trailer arm adapter 112 may include a series of apertures 140 that provide for reversibly securing the trailer arm adapter 112 to a trailer arm in a similar manner to the previous description. Also, the coupler arm adapter 114 may include a series of apertures 141 for reversibly securing the coupler arm adapter 114 to a coupler arm. The receiver 150 may include a pair of aligned apertures 152 positioned in opposing walls 154 of the receiver 150 for securing an accessory to the receiver 150. The receiver apertures 152 may be arranged to align with an aperture in a trailer accessory so that a pin 156 (shown in FIG. 12) may be passed though the receiver apertures 152 and the accessory aperture to secure the accessory 300 to the receiver 150.

Although the receiver 150 is illustrated and described as a hollow, square tube, it will be understood by those skilled in the art upon reading and understanding this disclosure that a receiver may be arranged in a variety of ways to facilitate the securing of an trailer accessory to an adapter. For example, the receiver may be arranged as a tube of another geometry, such as for example circular, rectangular, elliptical, and the like. In another example, the receiver may be arranged as an enclosed base extending from the surface of an adapter and arranged so that a hollow trailer accessory, such as a winch stand, slides over the base and is secured by a pin passing though aligned apertures in the base and winch stand.

The trailer arm adapter 112 and the coupler arm adapter 114 may be hinged such that the coupler arm adapter 114 moves pivotally with respect to the trailer arm adapter 112 similar to the above description of other embodiments. Such a hinged arrangement allows the coupler arm to fold backwards towards the trailer arm to reduce the overall length of the trailer.

Although the receiver 150 is described and illustrated as extending from the surface of the trailer arm adapter 112, it will be understood by those skilled in the art upon reading and understanding this disclosure that a receiver may be integrally formed with or otherwise incorporated into the coupler arm adapter 114. In another embodiment, receivers may be integrally formed or otherwise incorporated into each of the adapters 112, 114 so that multiple accessories may be secured to the trailer via the adapters 112, 114. In addition, the receiver 150 is illustrated as extending from the top surface 116 of the trailer arm adapter 112 at an angle. It will be readily understood that the receiver may extend vertically from the surface of the trailer arm adapter or may extend at any number of angles to accommodate the securing of a trailer accessory to the adapter.

The receiver 150 is described and illustrated as integrally formed with the trailer arm adapter 112. In another embodiment, a receiver is formed, fabricated, or otherwise manufactured separate from the trailer arm adapter and secured to the trailer arm adapter through a secondary process. Examples of such secondary processes are welding, bonding, overmolding, fusing, and the like. Forming a pivot hinge that includes a receiver for a trailer accessory provides for an assembly that is easily secured to a trailer and offers the functionality of selectively shortening the overall length of the trailer and selectively securing a trailer accessory to the trailer.

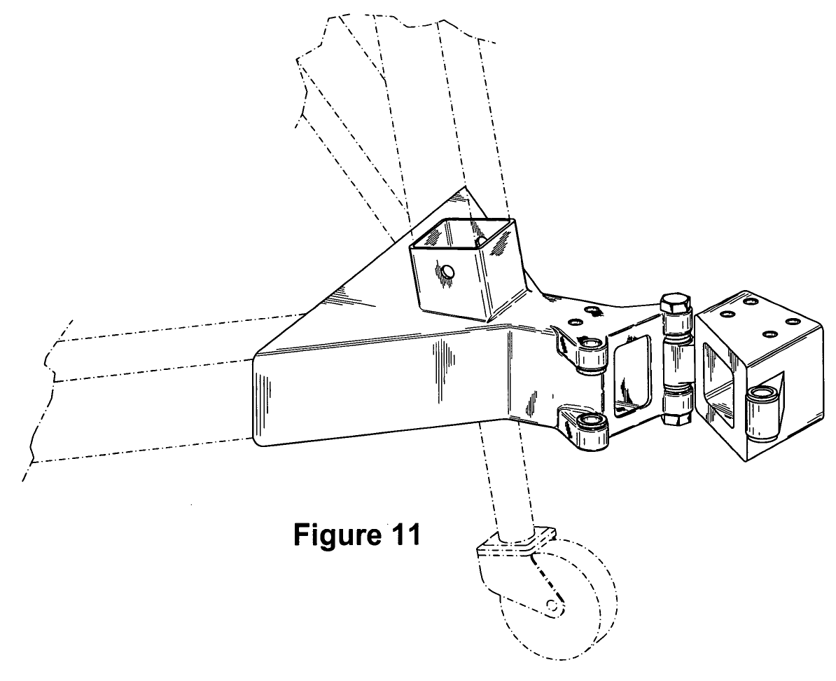

Another exemplary embodiment of a trailer arm adapter 212 is illustrated in FIG. 11. The adapter 212 includes a receiver 250 similar to that illustrated in FIGS. 9-10 and second receiver 260 or mounting tube extending from a sidewall 262 or side surface of the adapter 212. Such a mounting tube 260 may allow for a variety of trailer accessories to be secured to a trailer through the trailer adapter arm 212. In the embodiment shown, the mounting tube 260 is integrally formed with the trailer arm adapter 212. The adapter 212 and mounting tube 260 may be formed from a rigid material such as steel or a composite plastic and formed through casting, molding, or the like. The mounting tube 260 as illustrated is a hollow, circular tube extending horizontally from a side surface 262 of the adapter 212 and arranged to accept a trailer accessory such as a jack stand 350 (shown in FIG. 12). When the mounting tube 260 is arranged as a hollow, circular tube, a jack stand 350, for example, may be positioned within the mounting tube 260 so that it may swivel between a vertical position and a stored generally horizontal position. The mounting tube 260 may also include a clearance aperture 264 to accommodate protrusions extending from a trailer accessory.

Similar to previous descriptions a top surface 216 of the trailer arm adapter 212 may include a series of apertures 240 that provide for reversibly securing the trailer arm adapter 212 to a trailer arm. The mounting tube 260 may include a sleeve 266 arranged to accommodate a spring loaded pin (not shown) that may selectively lock the trailer accessory, such as a jack stand 350, in either a vertical or a stored generally horizontal position. In another embodiment, the mounting tube 260 may include a pair of aligned apertures (not shown) positioned opposite each other in the wall of the mounting tube 260 to secure a trailer accessory to the mounting tube 260. Such apertures may be arranged to align with an aperture in a trailer accessory so that a pin may be passed though mounting tube apertures and the accessory aperture to secure the trailer accessory to the mounting tube 260.

Although the mounting tube 260 is illustrated and described as a hollow, circular tube, it will be understood by those skilled in the art upon reading and understanding this disclosure that a mounting tube may be arranged in a variety of ways to facilitate the securing of a trailer accessory to the trailer arm adapter. For example, the mounting tube may be arranged as a tube of another geometry, such as for example square, rectangular, elliptical, and the like. In another example, the mounting tube may be arranged as an enclosed base extending from the side wall of an adapter and arranged so that a trailer accessory with an internal, hollow chamber slides over the base and is secured by a pin passing though aligned apertures in the base and trailer accessory.

Similar to previous descriptions, the trailer arm adapter 212 and a coupler arm adapter may be hinged such that the coupler arm adapter moves pivotally with respect to the trailer arm adapter 212. Such a hinged arrangement allows the coupler arm to fold backwards towards the trailer arm to reduce the overall length of the trailer.

Although the mounting tube 260 is described and illustrated as extending from a side wall 262 or side surface of the adapter 212, it will be understood by those skilled in the art upon reading and understanding this disclosure that a receiver or mounting tube may be integrally formed with or otherwise incorporated into a coupler arm adapter. In another embodiment, mounting tubes may be integrally formed or otherwise incorporated into both a trailer arm adapter and a coupler arm adapter so that multiple trailer accessories may be secured to the trailer via the adapters. In addition, the mounting tube 260 is illustrated as extending generally horizontally from the side wall 262 of the trailer arm adapter 212; however, it will be readily understood that a mounting tube may extend at an angle from the side wall of an adapter to accommodate the securing of an trailer accessory to the adapter. A receiver or mounting tube may also extend from any surface of an adapter to accommodate the securing of trailer accessories to a trailer.

The mounting tube 260 is described and illustrated as integrally formed with the trailer arm adapter 212. In another embodiment, a mounting tube is formed, fabricated, or otherwise manufactured separate from the trailer arm adapter and secured to the trailer arm adapter through a secondary process. Examples of such secondary processes are welding, bonding, overmolding, fusing, and the like. Forming a pivot hinge that includes a receiver for a trailer accessory provides for an assembly that is easily secured to a trailer and offers the functionalities of selectively shortening the overall length of the trailer and selectively securing one or more trailer accessory to the trailer.

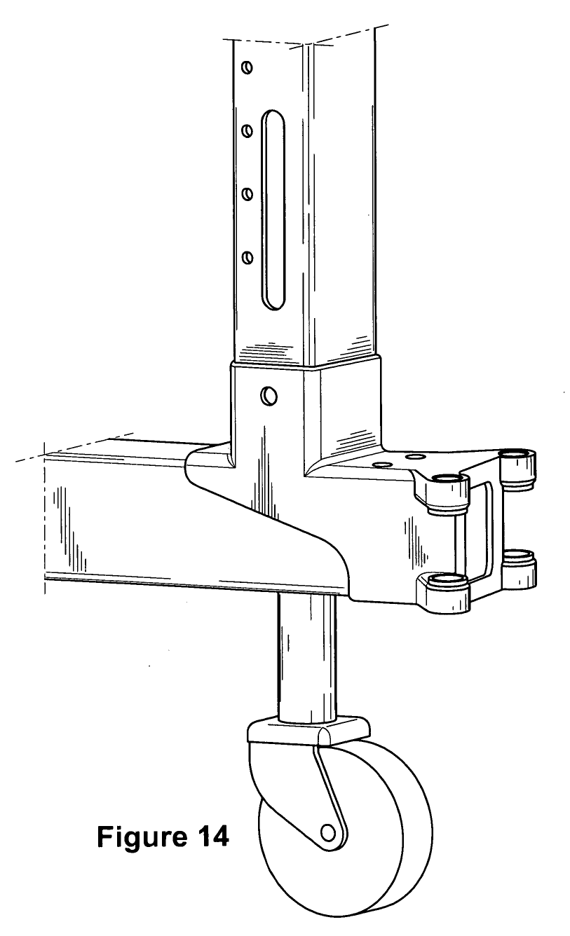

In another exemplary embodiment a trailer arm adapter 412 is arranged so that it may be secured to an A-frame type trailer 470. As illustrated in FIG. 13, the body of a trailer arm adapter 412 may be arranged to accommodate the front end of an A-frame trailer 470. A receiver 450 may be incorporated into the adapter 412 to accommodate a trailer accessory such as a winch stand 400. Similarly to previous descriptions, the receiver 450 may include a pair of apertures 452 arranged such that a trailer accessory may be positioned in the receiver 450 and a pin 456 may be passed through the receiver apertures 452 and an aperture in the accessory to secure the accessory to the adapter 450. A side wall 462 of the adapter 450 may include a series of apertures 440 for reversibly securing the adapter 412 to an A-frame trailer 470. It will be readily understood that a mounting tube as illustrated in FIG. 11 may be incorporated into the side wall 462 of the adapter 412.

In another embodiment of the invention, a receiver or mounting tube may be included in a sleeve arranged to slide onto a trailer or coupler arm. Once the sleeve is slid onto the trailer or coupler arm, it may be secured to the arm by welding or bonding. The sleeve may also be reversibly secured to the arm by passing fasteners through a series of apertures in the sleeve and matching apertures in the arm. The sleeve may include one or more receivers arranged to secure trailer accessories to the sleeve, and thus, secure the accessories to the trailer.

The invention has been described above and, obviously, modifications and alternations will occur to others upon the reading and understanding of this specification. The claims as follows are intended to include all modifications and alterations insofar as they come within the scope of the claims or the equivalent thereof.

We claim:

1. A pivot assembly for a towing trailer, the assembly comprising:
a first adapter attachable to a first trailer frame member, the first adapter comprising:
a body;
an engagement face forming a front surface of the body;
a pivot hinge member extending from the engagement face;
a coupling hinge member extending from the engagement face and opposed to the first pivot hinge member; and
a receiver adapted for securing a trailer accessory to the first adapter; and
a second adapter attachable to a second trailer frame member and pivotably attachable to the first adapter.

2. The pivot assembly of claim 1, where the receiver is integrally formed with the body of the first adapter.

3. The pivot assembly of claim 1, where the receiver is one of a plurality of receivers extending from the body of the first adapter.

4. The pivot assembly of claim 1, where the body includes a top surface; and
where the receiver extends from the top surface.

5. The pivot assembly of claim 4, where the receiver includes a passage passing though the receiver.

6. The pivot assembly of claim 5, where a cross-section of the receiver is rectangular in shape.

7. The pivot assembly of claim 1, where the body includes a side surface; and
where the receiver extends from the side surface.

8. The pivot assembly of claim 7, where the receiver includes a passage passing though the receiver.

9. The pivot assembly of claim 8, where a cross-section of the receiver is circular in shape.

10. The pivot assembly of claim 1, where the body includes a plurality of apertures for securing the first adapter to the first trailer frame member.

11. The pivot assembly of claim 1, where the receiver includes at least one aperture for securing the trailer accessory to the first adapter.

12. A pivot assembly for a tongue of a towing trailer, the assembly comprising:
a first adapter comprising:
a first engagement face positioned at an angle relative to a longitudinal axis through the first adapter;
a first pivot hinge member extending from the first engagement face;
a first coupling hinge member extending from the first engagement face and opposed to the first pivot hinge member; and
a first receiver adapted for securing a first trailer accessory to the first adapter; and
a second adapter comprising:
a second engagement face positioned at an angle relative to a longitudinal axis through the second adapter;
a second pivot hinge member extending from the second engagement face; and
a second coupling hinge member extending from the second engagement face and opposed to the second pivot hinge member.

13. The pivot assembly of claim 12, where the first receiver extends from a top surface of the first adapter and is sized and shaped to receiver a winch stand.

14. The pivot assembly of claim 12, where the first receiver extends from a side surface of the first adapter and is sized and shaped to receive a jack stand.

15. The pivot assembly of claim 12, where the first adapter further comprises a second receiver adapted to secure a second trailer accessory to the first adapter.

16. The pivot assembly of claim 15, where the first receiver extends from a top surface of the first adapter and the second receiver extends from a side surface of the first adapter.

17. The pivot assembly of claim 16, where the first receiver is rectangular in cross-sectional shape and the second receiver is circular in cross-sectional shape.

18. The pivot assembly of claim 15, where the first receiver and the second receiver are each integrally formed with the first adapter.

19. The pivot assembly of claim 12, where the second adapter further comprises a second receiver adapted for securing a second trailer accessory to the second adapter.

20. The pivot assembly of claim 19, where the first receiver extends from a top surface of the first adapter and the second receiver extends from a side surface of the second adapter.
